(19) United States
(12) Patent Application Publication
(10) Pub. No.: US 2026/0324603 A1
(43) Pub. Date: Oct. 22, 2026

(54) Autoclaved Aerated Concrete Beehive

(71) Applicant: Shelley Hive Co, Bend, OR (US)

(72) Inventors: Erin Leigh Coffelt, Bend, OR (US); Robert Otis Coffelt, Bend, OR (US)

(21) Appl. No.: 19/572,057

(22) Filed: Mar. 19, 2026

Related U.S. Application Data
(60) Provisional application No. 63/775,565, filed on Mar. 21, 2025.

(51) Int. Cl. A01K 47/06

(52) U.S. Cl. CPC A01K 47/06

(57) ABSTRACT

A beehive constructed primarily from autoclaved aerated concrete (AAC) provides a thermally stable, durable, pest-resistant environment for honeybee colonies. The hive includes AAC wall and lid components forming an insulated cavity for removable bee frames. Removable divider boards allow colony management and multi-colony configurations. Adjustable entrance gates provide open, closed, ventilation, and queen-excluder modes. Optional removable insulation panels enhance temperature regulation. The AAC structure mimics natural tree cavities, resists moisture and mold, allows interior sanitation, and reduces maintenance compared to traditional wooden hives.

### CROSS REFERENCE TO RELATED APPLICATIONS

This application claims the benefit of U.S. Provisional Patent Application No. 63/775,565 filed Mar. 21, 2024, the entirety of which is incorporated herein by reference.

### FIELD OF THE INVENTION

The present invention relates to beehives and apiculture equipment, and more particularly to beehives constructed using autoclaved aerated concrete (AAC) to provide improved thermal regulation, durability, pest resistance, and low-maintenance housing for honeybee colonies.

### BACKGROUND

Honeybee populations have been declining worldwide due to multiple stressors, including harsh weather conditions, diseases, and unsuitable hive environments. Traditional wooden hives, while common, have several shortcomings, including thermal limitations, pest and mold susceptibility, and maintenance and longevity issues.

Wooden hives often lack adequate insulation, resulting in heat loss during winter and excess heat during summer. They can harbor mold, pests, and pathogens and require frequent replacement after environmental wear. The present invention addresses these limitations by providing an AAC-based beehive structure with enhanced thermal stability, durability, and reusability.

### SUMMARY OF THE INVENTION

The invention provides a beehive constructed primarily from Autoclaved Aerated Concrete (AAC) to improve honeybee survival and colony health. The AAC structure offers inherent insulation, moisture resistance, and durability, and simulates a natural tree-cavity environment preferred by honeybees. The hive includes removable lids, adjustable entrance gates, divider boards for colony management, and optional insulation panels to further regulate temperature and airflow.

### BRIEF DESCRIPTION OF THE DRAWINGS

The accompanying drawings illustrate embodiments of the AAC beehive structure, including wall and base panels, lid elements, entrance gates, frame support structures, divider boards, and insulation components.

FIG. 1 is a perspective view of the AAC Beehive

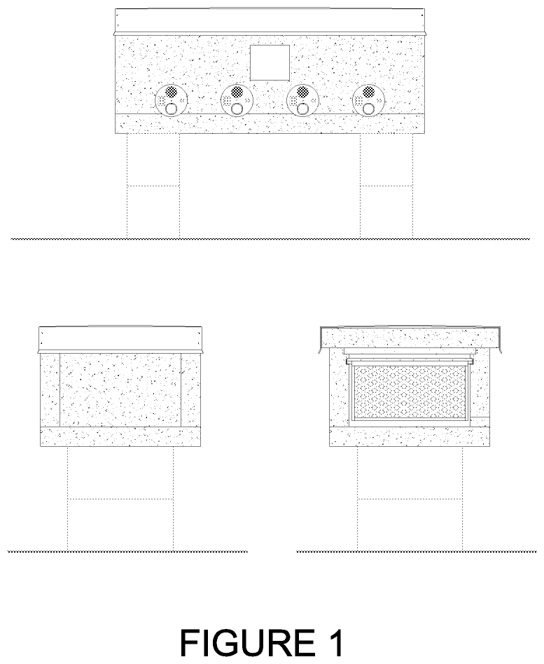

FIG. 2 is a base panel of the beehive

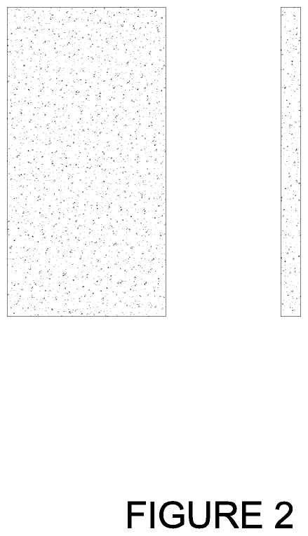

FIG. 3 is an entry ledge component

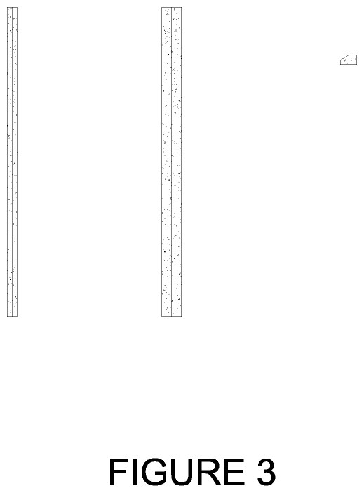

FIG. 4 is a front panel including entrance and ventilation gates

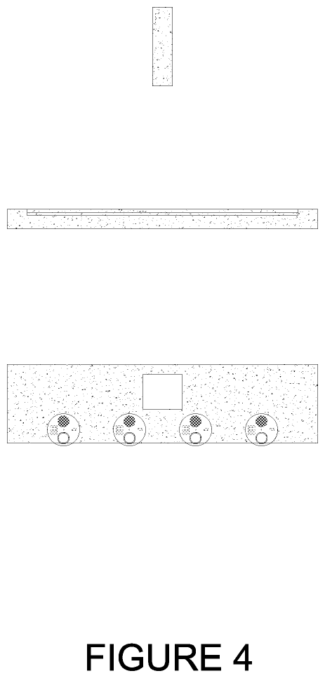

FIG. 5 is a back panel

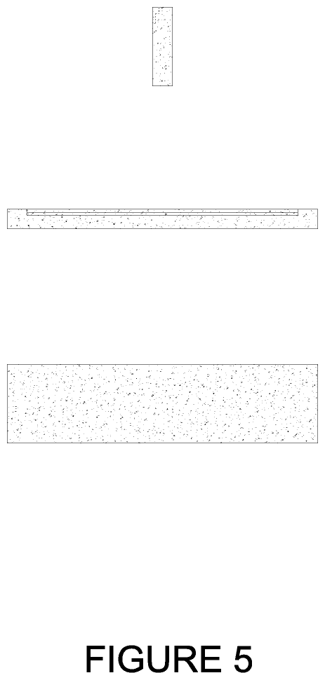

FIG. 6 is a side panel (typical for two)

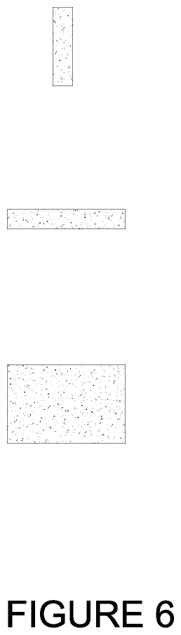

FIG. 7 is a lid block (typical for four)

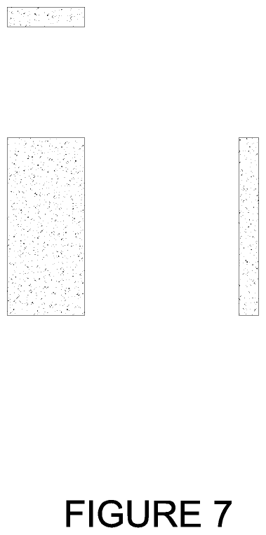

FIG. 8 is a divider board

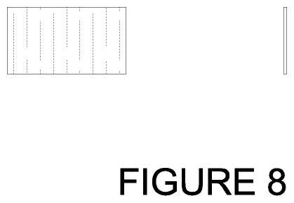

FIG. 9 is a top board (typical for seven)

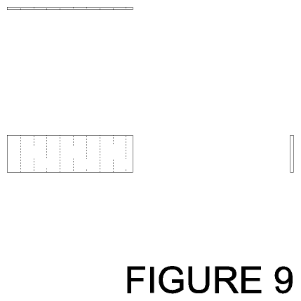

FIG. 10 is a hive frame track

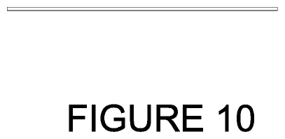

FIG. 11 is an insulation panel

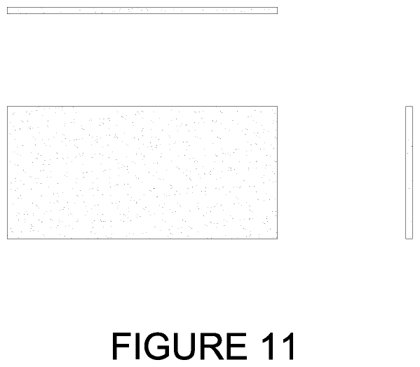

FIG. 12 is a cover lid

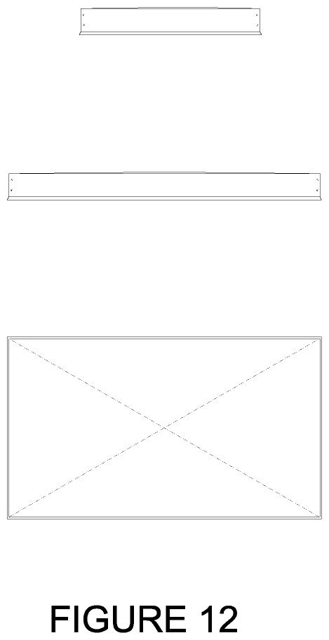

### DETAILED DESCRIPTION OF THE INVENTION

### Overview

The invention is a modular beehive constructed primarily from Autoclaved Aerated Concrete (AAC) panels designed to provide a thermally stable, pest-resistant, and durable environment for honeybee colonies. The design integrates various materials to ensure structural integrity, ease of assembly, and functionality.

### Key Components and Materials

AAC panels form the main structural walls, floor, and lids of the hive. CDX plywood is used as removable top boards and divider boards. Stainless-steel gates provide adjustable entrance and ventilation settings, including open, closed, queen-excluder, and ventilation modes. A wooden sill serves as a landing board at the entrance. An aluminum angle iron provides a frame track for suspending frames. A foil-faced rigid insulation panel may be used to enhance thermal regulation. A powder-coated steel outer cover protects the lid area from environmental elements. The exterior may be coated with natural lime wash for reflectivity and durability while maintaining breathability.

### Assembly and Functionality

AAC panels are cut to dimensions and assembled using adhesive and mechanical fasteners to create the hive body. Removable AAC lids are positioned above the internal cavity. Divider boards and top boards are used to regulate colony space and allow dual-colony housing when desired. Ventilation and entrance gates can be adjusted to accommodate colony needs across seasons. A reversible foil-faced insulation panel may be oriented seasonally for temperature control.

### Technical Considerations

The AAC body provides thermal mass that buffers temperature fluctuations. It is moisture-resistant and resists mold formation and pest harboring. The combination of AAC, metal reinforcement, and insulation creates a structure able to withstand environmental stress and routine hive management activities.

### ALTERNATIVE EMBODIMENTS OR VARIATIONS

Frame adaptability: In some embodiments, the beehive may be configured to accommodate different frame formats or sizes. Adaptability may be achieved through adjustable or interchangeable internal frame supports, dividers, or spacers. The embodiments described in detail herein are configured for standard Langstroth-style frames.

Additional features may include monitoring drawers, palletized systems for multiple-hive transport, and customized external dimensions to suit environment or space constraints.

### INTENDED USE AND APPLICATIONS

The AAC beehive is primarily intended for housing honeybee colonies to improve colony health, survivability, and ease of management. It may also provide controlled, insulated environments for other insects or niche agricultural applications requiring thermally stable enclosures.

What is claimed is:

1. A beehive comprising: a body formed from autoclaved aerated concrete (AAC); a base and a plurality of walls defining an interior cavity configured to receive removable bee frames; at least one removable AAC lid positioned above the interior cavity; at least one entrance including a gate configured to selectively provide at least an open mode and a closed mode; and one or more removable divider boards configured to partition the interior cavity into separate sections for colony management.

2. The beehive of claim 1, wherein the AAC body provides thermal insulation sufficient to reduce internal temperature fluctuations relative to ambient external temperature.

3. The beehive of claim 1, wherein at least one entrance gate includes a ventilation mode and a queen-excluder mode.

4. The beehive of claim 1, further comprising removable top boards positioned above the frames to restrict bee movement while permitting beekeeper access.

5. The beehive of claim 1, further comprising an insulation panel positioned above the frames and below the removable lid.

6. The beehive of claim 1, wherein interior AAC surfaces are untreated to promote propolis deposition by bees.

7. The beehive of claim 1, wherein the beehive is dimensioned to receive Langstroth-style frames and to maintain bee space appropriate for honeybee movement and comb construction.
